(19) United States
(12) Patent Application Publication
(10) Pub. No.: US 2024/0397864 A1
(43) Pub. Date: Dec. 5, 2024

(54) ADAPTIVE HEADER FLOATATION FOR TILT AND/OR LIFT POSITION

(71) Applicant: CNH Industrial America LLC, New Holland, PA (US)

(72) Inventors: Glenn Bird, Leola, PA (US); Kevin Hanson, Akron, PA (US); Neseth Kong, Leola, PA (US); Todd Rayburn, Parkton, MD (US); Jonathan Eaby, Lancaster, PA (US); Jeffrey Fay, II, Oxford, PA (US)

(73) Assignee: CNH Industrial America LLC, New Holland, PA (US)

(21) Appl. No.: 18/204,030

(22) Filed: May 31, 2023

(51) Int. Cl. A01D 41/14

(52) U.S. Cl. CPC A01D 41/141; A01D 41/145

(57) ABSTRACT

Float performance of a header is enhanced by using tilt position and/or lift position changes of the header to automatically adjust ground reaction force when operating conditions require a change in tilt and/or lift position of the header, such as for cutting certain crops, cutting in certain conditions, or to maintain a mechanical advantage. Using an equation to relate the changing down force with the tilt and/or lift positions, the floatation setting of the header is changed to maintain a constant ground reaction force. The adaptive floatation avoids the need for the operator to exit the vehicle to check and, if necessary, adjust the floatation force after each tilt and/or lift adjustment.

### BACKGROUND OF THE INVENTION

Various types of agricultural vehicles use headers to process crop materials. For example, windrowers (also known as swathers) are used to cut crop material and form it into windrows (a cut row or material) that is later processed, typically after drying, by other equipment. Similarly, combine harvesters use headers to process crop materials, which are conveyed into a crop processing system located on the chassis of the vehicle. In either case, it is often desirable to movably mount the header to the chassis of the vehicle to allow height adjustment and/or tilt adjustment.

It is also often desirable to mount the header such that it can move to follow or “float” over undulating terrain. Similar capability is often desirable in multi-segment headers to allow an articulated portion of the header to adjust or float relative to an adjacent part of the header. Header floatation refers to support by the chassis or vehicle of a majority of the header weight, but not all, in order to effectively push the header forward in contact with the ground, with a small amount of predetermined force acting between the header and the ground. This keeps optimal ground following, while keeping operation of the machine most efficient.

A typical self-propelled windrower has a header that is movably mounted to the vehicle chassis by lift arms actuated by hydraulic actuators. The bulk of the weight of the header is supported by lift arms attached to and actuated by hydraulic cylinders. The hydraulic actuators comprise piston and cylinder assemblies that use hydraulic fluid to move the piston relative to the cylinder. The position of the header is controlled by changing the volume of fluid in the cylinder. Float is provided by including an accumulator in the hydraulic circuit. A typical accumulator is a reservoir that is fluidly connected to the hydraulic circuit, and contains a volume of pressurized gas. In use, as the header moves over undulating terrain, the gas can expand and contract to provide a spring-like resilience to the hydraulic circuit. Thus, the header is effectively suspended on an air spring.

It will be appreciated from the foregoing that the gas pressure dictates the spring force, and therefore controls the amount of force required to allow the header to float. The spring force can be adjusted by varying the state of a pressure reducing valve connected to the accumulator. For example, in one known system, a pressure reducing valve (“PRV”) is used to control the pressure. This device operates by using an electric current to set the PRV operating state. The operator can adjust the current to the PRV using a toggle switch or other controls.

An example of a system for controlling the header position using pressurized hydraulic fluid is provided in U.S. Pat. No. 5,633,452, which is incorporated herein by reference. In this example, the header height is established by setting a pressure in hydraulic header lift cylinders, and float is provided by providing an accumulator in the hydraulic circuit. A pressure sensor is used to determine if the hydraulic pressure in the circuit drops below a minimum safe value, and automatically raises the pressure when this happens. This system relies on sensing the hydraulic pressure of the hydraulic circuit, which can lead to problems. For example, friction in the hydraulic cylinders (so-called “stiction”), as well as at other locations such as pivots, can cause force reactions that make the hydraulic pressure of the fluid inaccurate as a measure of the actual header height setting. For example, during efforts to lift the header, a sticking hydraulic cylinder can generate high hydraulic pressure, without a corresponding increase in header height. U.S. Publication No. 2022/0053693 A1, PCT Publication No. WO2022/046769 A1, U.S. Pat. No. 7,168,226, and U.S. Publication No. 2006/0254239 also show systems for controlling a header, and these references are incorporated herein by reference.

Such systems are functional, but can suffer from various problems that cause the actual floatation force to vary significantly for a given current setting. The purpose of floatation pressure is to keep a majority of the weight of the header off the ground; a typical goal is to have 200 to 300 pounds of force on the ground for a header having a dead weight of four to eight thousand pounds or more. The intent is for downforce to remain consistent across all terrain. This is not easily achieved, and will not always be exactly the same as ground conditions move the header up and down in comparison to the tractor. Thus, an experienced operator must occasionally adjust the signal to the PRV to maintain the desired floatation force.

In addition, due to a machine's current lift arm architecture, there may be a different mechanical advantage of the lift arms at different positions of the lift cylinders. This can cause inadequate downward floatation below the point of maximum mechanical advantage. To compensate for this, operators may need to take an active approach to the control of the header by manually lowering the head after hills or increasing the floatation ground force. The increase in ground force can cause excessive wear on the skid shoes and cutter bar knives, as the header carves into the ground.

Tilt adjustment can also cause larger or smaller than desired ground forces between the header and ground. Header tilt is set by the operator, dependent on crop and ground conditions for a specific type of cut, typically by adjusting a pressure control valve attached to an accumulator for controlling a hydraulic actuator that rotates the header about a pivot axis running transverse to the vehicle's fore-aft axis. Once the lift actuators are set to the desired floatation pressure to achieve a constant downforce from the header to the ground, a change in tilt angle will move the center of gravity closer to or further from the header pivot on the lift arms and may result in a down force from header to ground that is outside desired tolerances, requiring the operator to reset the floatation pressure for each tilt position change. The inventors have determined that the state of the art of header floatation system can still be improved.

This description of the background is provided to assist with an understanding of the following explanations of exemplary embodiments, and is not an admission that any or all of this background information is necessarily prior art.

### SUMMARY OF THE INVENTION

In one exemplary aspect, a method of operating a header float control system of an agricultural vehicle having a header movably mounted to a chassis is provided. The method comprises the steps of: determining for the header a relation between a tilt position and/or a lift position of the header and a ground reaction force between the header and a ground surface in contact with the header; setting a desired ground reaction force between the header and a ground surface in contact with the header; changing the tilt and/or lift position of the header; and adjusting a lift pressure of the header according to the relation between header tilt position and/or the header lift position and ground reaction force to maintain the desired ground reaction force.

In some exemplary aspects, determining the relation between header tilt position and/or lift position and ground reaction force comprises measuring the ground reaction force between the header and the ground surface at one or more tilt and/or lift positions of the header.

In some exemplary aspects, setting a desired ground reaction force comprises receiving a selection of an adjustable value for the desired ground reaction force.

In some exemplary aspects, the adjustable value for the desired ground reaction force comprises an operating pressure of a hydraulic actuator that controls a lift position of the header relative to the chassis.

In some exemplary aspects, changing the tilt position and/or lift position of the header comprises receiving a selection of an adjustable value for the tilt position and/or lift position.

In some exemplary aspects, adjusting the lift pressure of the header to maintain the desired ground reaction force comprises adjusting an operating pressure of a hydraulic actuator that controls the lift position of the header relative to the chassis.

In some exemplary aspects, adjusting the operating pressure of the hydraulic actuator that controls the lift position of the header relative to the chassis comprises changing an output pressure of a pressure reducing valve operatively connected to the hydraulic actuator that controls the lift position of the header relative to the chassis.

In another exemplary aspect, an agricultural vehicle is provided, comprising: a chassis; a header movably mounted to the chassis by one or more lift arms, the one or more lift arms configured to adjust a lift position of the header relative to the chassis actuated by one or more lift position hydraulic actuators, and the header configured to adjust a tilt position relative to a ground surface located below the header actuated by one or more tilt position hydraulic actuators; and a control system operatively connected to the lift and tilt actuators and configured to: determine for the header a relation between a tilt position and/or a lift position of the header and a ground reaction force between the header and a ground surface in contact with the header; set a desired ground reaction force between the header and a ground surface in contact with the header; change the tilt position and/or lift position of the header; and adjust a lift pressure of the one or more lift actuators according to the relation between header tilt position and/or lift position and ground reaction force to maintain the desired ground reaction force.

In some exemplary aspects, the control system comprises a user interface configured to receive a selection of an adjustable value for the desired ground reaction force.

In some exemplary aspects, the control system comprises a user interface configured to receive a selection of an adjustable value for the header tilt position and/or the header lift position.

In some exemplary aspects, the control system is operatively connected to a pressure reducing valve that is configured to adjust the operating pressure of the one or more lift position hydraulic actuators.

### BRIEF DESCRIPTION OF THE DRAWINGS

Embodiments of inventions will now be described, strictly by way of example, with reference to the accompanying drawings, in which:

FIG. 1 is a side elevation schematic view of an agricultural windrower configured for use with a header float control system;

FIG. 2 is a cutaway side elevation detail of an agricultural windrower configured for use with a header float control system, showing the movable attachment of the header to the vehicle chassis;

FIG. 3 is an isometric detail of the movable attachment of the header to the vehicle chassis, showing the lift and floatation apparatus of the header;

FIG. 4 is an isometric detail of the movable attachment of the header to the vehicle chassis, showing the tilt apparatus of the header;

FIG. 5 is a schematic illustration of an exemplary header float control system;

FIG. 6 is a flow chart illustrating an exemplary method for operating a header float control system;

FIG. 7 is a schematic illustration of a hydraulic system for controlling a header; and

FIG. 8 is a schematic illustration of a hydraulic system for controlling a header, shown in a different valve configuration.

In the figures, like reference numerals refer to the same or similar elements.

### DETAILED DESCRIPTION OF THE INVENTION

Embodiments described herein provide a method of operating a header float system of an agricultural vehicle having a header movably mounted to a chassis by an actuator system to maintain a constant, predetermined ground reaction force between a header component and the underlying ground during operation of the header. Embodiments are shown in use with windrower headers, but other embodiments may be used with other mechanisms that contact the ground.

The terms “crop” and “crop material” are used to describe any mixture of grain, seeds, straw, tailings, and the like. “Grain” or “seeds” refer to that part of the crop material which is threshed and separated from the discardable part of the crop material (e.g., straw and tailings), and includes grain in aggregate form such as an ear of corn. The portion of the crop material that generally is discarded or not used for food or growing purposes may be referred to as non-grain crop material, material other than grain (MOG) or straw.

Also, the terms “forward,” “rearward,” “left,” and “right”, when used in connection with the agricultural harvester (e.g. combine) and/or components thereof are usually determined with reference to the direction of forward operative travel of the combine, but again, they should not be construed as limiting. The terms “longitudinal” and “transverse” are determined with reference to the fore-and-aft direction of the agricultural combine and are equally not to be construed as limiting.

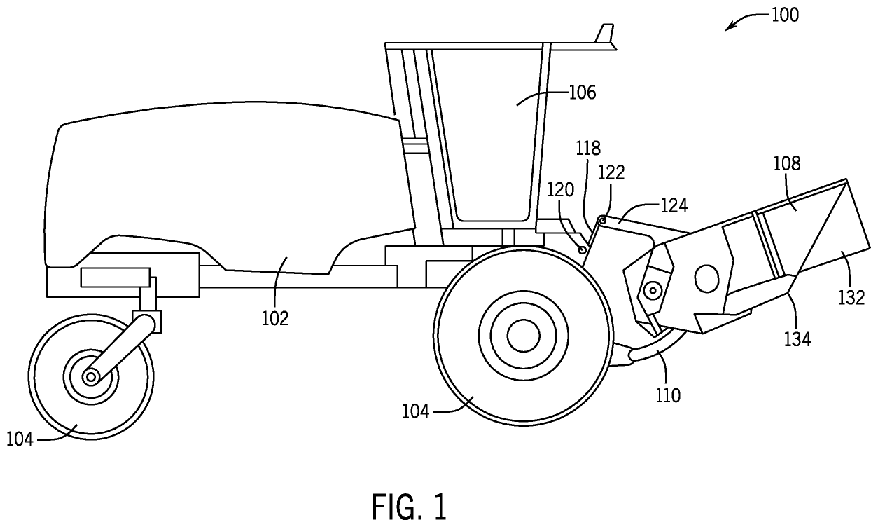

FIG. 1 shows an example of an agricultural vehicle 100 in the form of a self-propelled windrower. The vehicle 100 has a chassis 102 that is supported for movement on the ground by wheels 104 or the like, and one or more motors (not shown) are provided to power the wheels 104 and other systems. The vehicle 100 may have an operator's cab 106, and other features typical of a self-propelled windrower. A header 108 is movably mounted to the chassis 102, such as by being mounted on pivoting lift arms 110, four-bar linkages, linear slides, or the like. The header 108 includes one or more operating components, such as disc or sickle head cutters (not shown), that process the crop materials.

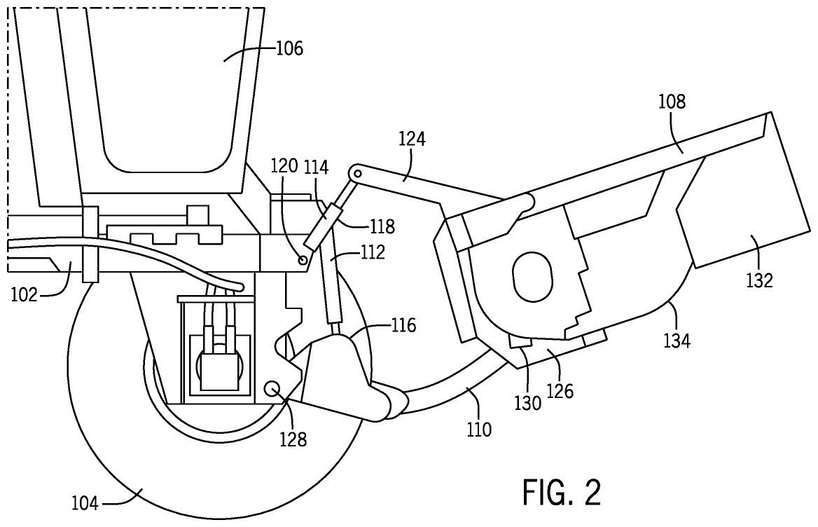

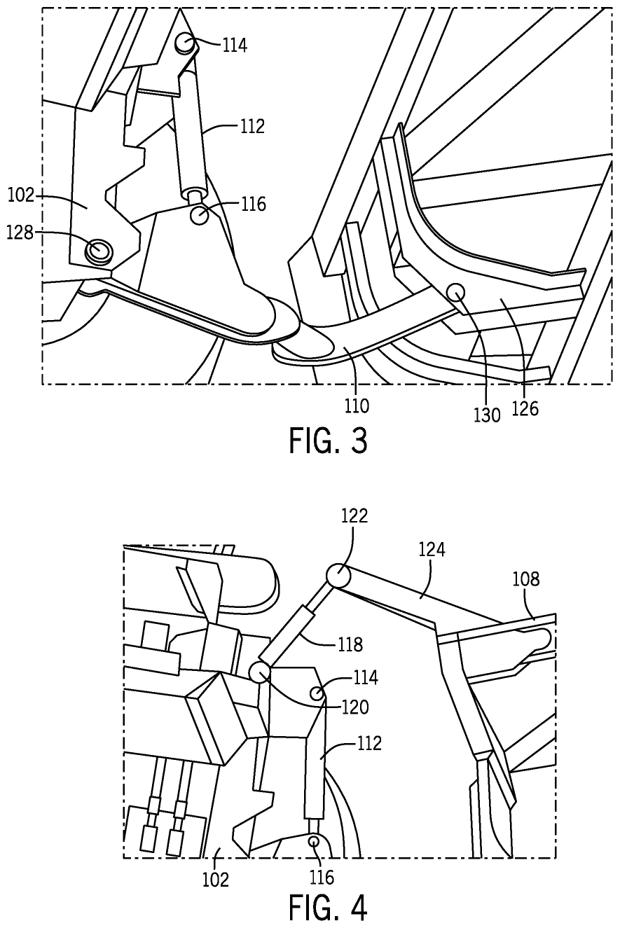

Referring also now to FIGS. 2, 3, and 4, one or more lift actuators 112 are provided to control the position of the header 108 relative to the chassis 102. The lift actuators 112 typically comprise hydraulic actuators, such as telescoping piston/cylinder assemblies, but other actuators may be used (e.g., pneumatic or electric actuators). Lift cylinders 112 are connected at one end to the vehicle chassis 102 by a pivot 114 and at the opposite end to lift arm 110 by a pivot 116. Lift arms 110 are connected at one end to chassis 102 by pivot 128 and at the opposite end to header frame 126 by pivot 130. Also provided are one or more hydraulic tilt actuators 118 to control the tilt angle (cutting angle) of the header 108 relative to the chassis 102 and/or to the ground beneath the header. Tilt cylinders 118 are connected at one end to the vehicle chassis 102 by a pivot 120 and at the opposite end by a pivot 122 to a mounting point 124 on the header frame 126.

Actuators 112, 118, pivots 114, 116, 120, 122, 128, and 130, lift arms 110, mounting point 124, and/or other header 108 suspension components may comprise one or more sensors for determining the position(s) of each and/or all of the suspension components mounting header 108 to chassis 102. For example, lift actuators 112 or tilt actuators 118 may comprise a sensor for determining the position of the actuator piston in the actuator cylinder. Lift pivot 128 may comprise a sensor for determining the lift position of the header relative to the chassis 102, and tilt pivot 130 may comprise a sensor for determining the tilt position of the header relative to the chassis 102 and/or the lift arms 110 and/or to the ground beneath the header 108. The position sensor(s) may comprise a linear potentiometer, a rotary potentiometer or encoder (since the header 108 is pivotably coupled to the chassis 102 at pivot 128 and to the lift arms 110 at pivot 130), pressure sensors on actuator cylinders 112 and/or 118, or any other apparatus or device known to those of skill capable of sensing a position in the header 108 suspension components and enabling a signal indicating the position to be received by the control system 500.

The header 108 also includes operating components, such as crop cutters (not shown), and associated parts such as rock guards 132, which typically are arrayed along the leading edge of the header frame 126. Header support members 134, such as skid shoes (shown) or wheels (not shown), are arranged along the bottom of the header frame 126. The support members 134 may be mounted to the frame 126 by direct bolted connection or by pivots or the like. For example, each support member 134 may be pivotally mounted to rotate or flex about a respective pivot axis (not shown). The pivot axes of the support members 134 may be co-linear or offset from each other. In some cases, at least one support member 134 is provided at each side of a lateral centerline of the header 108, to provide support at each end of the header 108. In some cases, however, such as when the header 108 is a wing section attached to a center section, a single support member 134 may be used. The support members 134 are positioned between the underlying ground surface and the remainder of the header 108 or the suspended portions thereof and collectively carry the total weight of the header 108 or the suspended portion of the header 108 that is being supported by the ground at any given time. The remainder of the header 108 weight will be supported by the vehicle chassis 102 by way of the actuators 112 and lift arms 110.

The position sensors (not shown) for the actuator(s) 112 and/or 118 and/or other header suspension components (e.g., lift arms 110, pivots 128, 130, etc.) may be electrically connected to a wiring harness for providing power to and return signals from the position sensors. Other embodiments may use battery-powered systems to operate the position sensors and send wireless signals of the position sensors' data output. The header 108 also may include an electrical terminal (not shown) that can be connected to an electrical control system 500, such as discussed below.

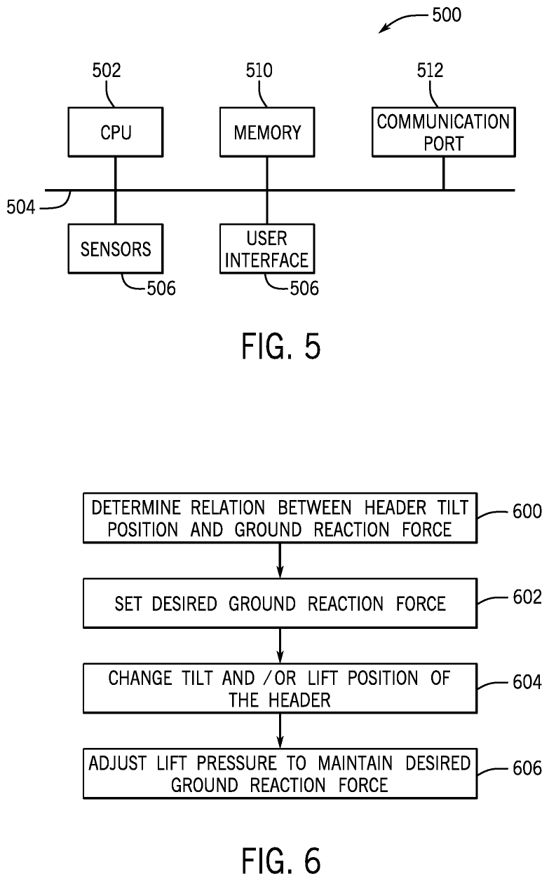

FIG. 5 is a block diagram of exemplary hardware and computing equipment that may be used as a control system 500 to control the float characteristics of the header 108. The control system 500 includes a central processing unit (CPU) 502, which is responsible for performing calculations and logic operations required to execute one or more computer programs or operations. The CPU 502 is connected via a data transmission bus 504, to sensors 506 (e.g., position sensors on actuators 112, mounting points 124, swing arms 110, pivots 128, 130, or other header 108 suspension components), a user interface 508, and a memory 510. The user interface 508 may comprise any suitable device for providing user input to or output from the control system 500, such as toggle switches, dials, digital switches, touchscreen displays, and the like. The control system 500 also has a communication port 512 that may be operatively connected (wired or wirelessly) to the header's electrical terminal (not shown). One or more analog to digital conversion circuits may be provided to convert analog data from the sensors 506 to an appropriate digital signal for processing by the CPU 502, and signal conditioning circuits may be used to filter or perform other functions on the raw data, as known in the art.

The CPU 502, data transmission bus 504 and memory 510 may comprise any suitable computing device, such as an INTEL ATOM E3826 1.46 GHZ Dual Core CPU or the like, being coupled to DDR3L 1066/1333 MHZ SO-DIMM Socket SDRAM having a 4 GB memory capacity or other non-transitory memory (e.g., compact disk, digital disk, solid state drive, flash memory, memory card, USB drive, optical disc storage, etc.). The CPU 502 also may comprise a circuit on a chip, microprocessor, or other suitable computing device. The selection of an appropriate processing system and memory is a matter of routine practice and need not be discussed in greater detail herein. The control system 500 may be integrated into an existing vehicle control system, added as a new component, or be a self-contained system.

It is to be understood that operational steps performed by the control system 500 may be performed by the controller upon loading and executing software code or instructions which are tangibly stored on a tangible computer readable medium, such as on a magnetic medium, e.g., a computer hard drive, an optical medium, e.g., an optical disc, solid-state memory, e.g., flash memory, or other storage media known in the art. Thus, any of the functionality performed by the controller described herein is implemented in software code or instructions which are tangibly stored on a tangible computer readable medium. Upon loading and executing such software code or instructions by the controller, the controller may perform any of the functionality of the controller described herein, including any steps of the methods described herein.

The term “software code” or “code” used herein refers to any instructions or set of instructions that influence the operation of a computer or controller. They may exist in a computer-executable form, such as machine code, which is the set of instructions and data directly executed by a computer's central processing unit or by a controller, a human-understandable form, such as source code, which may be compiled in order to be executed by a computer's central processing unit or by a controller, or an intermediate form, such as object code, which is produced by a compiler. As used herein, the term “software code” or “code” also includes any human-understandable computer instructions or set of instructions, e.g., a script, that may be executed on the fly with the aid of an interpreter executed by a computer's central processing unit or by a controller.

The inventors have determined that the float performance of a header 108 can be enhanced by using tilt position changes of the header 108 relative to the ground surface located below the header to automatically adjust for the change in ground reaction force that is caused when operating conditions require a change in tilt position of the header, such as for cutting certain crops or cutting in certain conditions. Using an equation to relate the changing down force with the tilt position for a given header, the floatation setting of the header is changed to maintain a constant ground reaction force. By using software and tilt position feedback of the header 108, the machine can automatically adjust the header lift (floatation) force in response to a change in the header tilt position, which can cause the header to experience insufficient or excessive ground reaction force. A downward tilt of the header will increase the ground reaction force, and in response, header floatation pressure will increase to reduce the ground reaction force. An upward tilt of the header will decrease ground reaction force, and in response, header floatation pressure will decrease and ground reaction force will increase. The adaptive floatation according to the invention avoids the need for the operator to exit the vehicle to check and, if necessary, adjust the floatation force after each tilt adjustment.

FIG. 6 illustrates an exemplary method for operating a header control system 500 to adjust the float characteristics of a header 108 based on tilt position and/or lift position changes of the header 108. The method includes the following parts: 600 determining for the header 108 a relation between a tilt position and/or a lift position of the header 108 and a ground reaction force between the header 108 and a ground surface in contact with the header 108; 602 setting a desired ground reaction force between the header 108 and a ground surface in contact with the header 108; 604 changing the tilt position and/or the lift position of the header 108; and 606 adjusting a lift pressure of the header 108 according to the relation between header 108 tilt position and/or lift position and ground reaction force to maintain the desired ground reaction force.

The desired ground reaction force is the desired amount of force exerted between the header 108 (or the suspended portion, such as a wing section or subassembly, of the header 108) and the ground. This value may be a single value representing the total header weight (e.g., a total of x pounds force among all of the supports 134), or it may be divided into target ground reaction forces at multiple locations along the header 108 (e.g., x/2 pounds force at each of two supports 134). Dividing the target value into multiple forces at different locations may have the benefit of helping to ensure that the weight of the header 108 is not concentrated at a single location. Dividing the target value into multiple forces also can be used to perform separate control feedback loops at different actuators 112 associated with different supports 134. The desired ground reaction force also may vary depending on the particular support 134, such as when certain components and their associated supports 134 are desired to carry more or less weight. The desired ground reaction force also may be selected based on other factors, such as the position of the header 108 or header 108 subassembly relative to the vehicle chassis 102 or the rest of the header 108. For example, the desired ground force might vary depending on the position of flex arms holding operating components (e.g., higher force allowed or desired at higher vertical elevations, or vice-versa). Such values can be set according to predetermined equations or using lookup tables, or modified by manual user adjustment. Other alternatives and variations will be apparent to persons of ordinary skill in the art in view of the present disclosure.

Determining 600 for the header 108 a relation between a tilt position and/or a lift position of the header 108 and a ground reaction force between the header 108 and a ground surface in contact with the header 108 can be accomplished in various ways. The control system 500 may attempt to detect and identify the header 108 by querying the header 108 electronics via the header's electrical terminal (not shown) or other communication path (e.g., wireless) with the header 108. Such query may comprise a signal sent to the header 108 to determine properties of the header 108 (e.g., a particular ground reaction force associated with a range of tilt positions and/or lift positions encompassing a range of tilt and/or lift positions at regular intervals from zero position (fully raised) to fully deployed (maximum tilt or lowering towards the ground), or a signal sent to a processor or circuit in the header 108 that is configured to return a header identification code or signal. The query also may be sent to other operating systems of the vehicle 100, which may be programmed to have the identity of the header 108. The identity of the header 108 may be, for example, an indicator of a particular class of headers (e.g., windrower headers, harvester headers), type of header (e.g., windrower headers with a particular blade arrangement), or it may be a unique identifier of an individual header. The identity of the header 108 also may indicate other variables, such as the particular size or width of the header. This may be useful to determine how many supports 134 will be part of the control system 500, knowing an area over which the load is distributed for determining average ground pressure, and so on. If the control system 500 in step 600 is able to identify the header 108, it then obtains a predetermined relation between header 108 tilt position and/or lift position and ground reaction force that is associated with the header 108.

In step 602, a desired ground reaction force is set between the header 108 and the ground in contact with the header. The desired ground reaction force may be set manually by the operator, or the control system 500 can automatically set a desired ground reaction force as a predetermined ground force value. The control system 500 in step 602 also may be configured to allow the operator to adjust the desired target ground reaction force, based on operating conditions or other factors. Thus, the control system 500 can update the desired ground reaction force if an operator adjustment is received (e.g., add or subtract a user-selected adjustment amount value, or replace the total value with the user-selected total value). The control system 500 in step 602 may also use a default value, or receive a user-selected adjustable value of the desired ground reaction force from the user interface 508.

In step 604, the tilt and/or lift position of the header 108 is changed. This can be accomplished manually by the operator, or through control system 500, for example, by operator input at the user interface 508, or automatically by control system 500 in a predetermined way, for example, in response to a changing harvest condition. As previously described, in a preferred embodiment, one or more tilt actuators 118 are provided to control the tilt position of the header 108 relative to the chassis 102, lift arms 110, and/or the ground surface below the header 108. The tilt actuators 118 typically comprise hydraulic actuators, such as telescoping piston/cylinder assemblies, but other actuators may be used (e.g., pneumatic or electric actuators). In a preferred embodiment, tilt actuators 118 and/or pivots 130 further comprise one or more sensors (not shown) for determining the tilt position of the header 108. The tilt position sensor may comprise a linear potentiometer, a rotary potentiometer or encoder (since the header 108 is pivotably coupled to the lift arms 110), pressure sensors on both sides of the cylinder, or any other apparatus or device known to those of skill capable of sensing a position in device and enabling a signal indicating the position to be received by the control system 500. The positions of the tilt actuators 118, pivots 130, and/or other header 108 suspension components are correlated in step 600 to the tilt positions of the header 108 and therefore serve as data points for the tilt positions of the header 108 relative to the ground surface located below the header.

Similarly, and as previously described, in a preferred embodiment, one or more lift actuators 112 are provided to control the lift position of the header 108 relative to the chassis 102 and/or the ground surface below the header 108. The lift actuators 112 typically comprise hydraulic actuators, such as telescoping piston/cylinder assemblies, but other actuators may be used (e.g., pneumatic or electric actuators). In a preferred embodiment, lift actuators 112 and/or lift pivots 128 further comprise one or more sensors (not shown) for determining the lift position of the header 108. The lift position sensor(s) may comprise a linear potentiometer, a rotary potentiometer or encoder (since the lift arms 110 are pivotably coupled to the chassis 102 at lift pivots 128), pressure sensors on both sides of the cylinder, or any other apparatus or device known to those of skill capable of sensing a position in device and enabling a signal indicating the position to be received by the control system 500. The positions of the lift actuators 112, lift arms 110, lift pivots 128, and/or other header 108 suspension components are correlated in step 600 to the lift positions of the header 108 and therefore serve as data points for the lift positions of the header 108 relative to the chassis 102 and/or ground surface located below the header.

In step 606, control system 500 adjusts a lift pressure of the header according to the relation between header tilt position and/or lift position and ground reaction force determined in step 600 to maintain the desired ground reaction force between the header 108 and the ground. Control system 500 obtains output signals from the position sensors on the header suspension components to determine the tilt position of the header 108. The raw data from the position sensors may be processed in a variety of ways to remove noise, account for transient loads caused during operation, remove contributions caused by regular vibrations (e.g., cyclical vibrations caused by the cutters), smooth the data, and so on. The control system 500 may also preferably includes, during the control loop, a step (not shown) of determining whether the operator has adjusted the desired ground force target value and updating the ground force target value accordingly. Control system 500 relates the change in tilt position of the header 108 to a change in ground reaction force according to the relation for the header 108 determined in step 600 adjusts one or more operating parameters of the lift actuators 112 to maintain the desired ground reaction force between the header 108 and the ground following the change in the header 108 tilt position in step 604.

In one embodiment, control system 500 changes the hydraulic pressure on the rod end of the hydraulic lift cylinder 112 that supports the weight of the header 108. A pressure-reducing valve and a pump in the vehicle hydraulic circuit operate to increase or decrease the floatation pressure, which has an inverse correlation to ground reaction force. An increase in float pressure encourages upward motion of the header 108 relative to the chassis 102 after a downward tilt or lowering of header 108 raises the ground reaction force, decreasing header 108 weight on the ground, decreasing header wear, and lessening accumulation of mud and other debris on the header 108. A decrease in float pressure encourages downward motion of the header 108 after an upward tilt or lift of header 108 lowers the ground reaction force, increasing header weight on the ground, causing the header 108 to more closely follow the ground, and cutting more crop.

It will be appreciated that the foregoing method may be modified in various ways, or replaced by a different control method. For example, the header control system 500 may be operated by setting a target maximum ground force, and controlling the actuators 112 to maintain the desired ground force below the maximum value. This may be helpful, for example, to avoid “bulldozing” the soil in certain ground conditions, and to prevent potentially damaging overloads. Such a control process may be added to the foregoing process, or used as a separate process. Other alternatives and variations will be apparent to persons of ordinary skill in the art in view of the present disclosure.

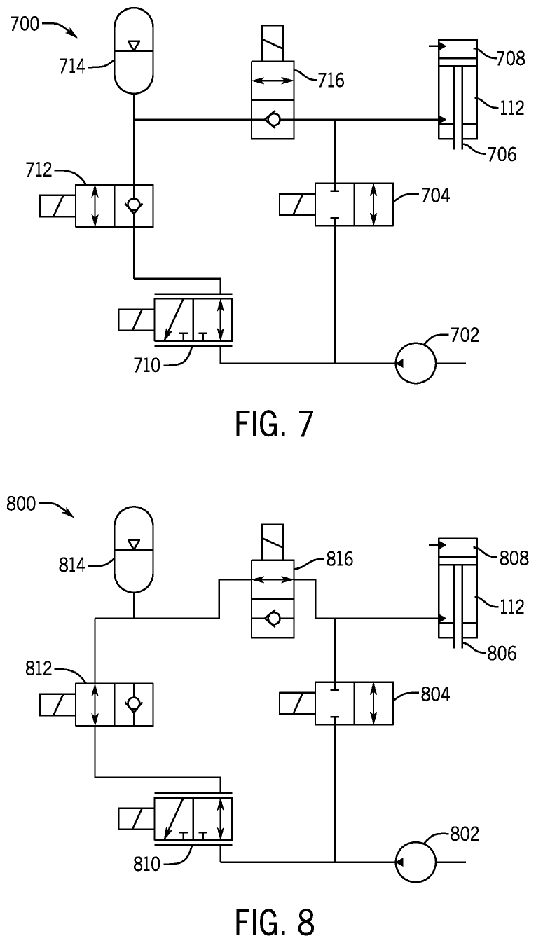

FIG. 7 illustrates an example of a hydraulic system 700 that may be used to control the header 108 system to achieve uniform ground reaction forces as described above. The hydraulic system 700 generally includes a lift actuator 112 that is controlled by a source of pressurized hydraulic fluid such as a hydraulic pump 702 and control valves.

In this example, a position control valve 704 is connected between the lift actuator 112 and the pump 702, and operable to increase or decrease the static volume of hydraulic fluid in the lift actuator 112 cylinder. In the open position, the pump 702 directs fluid into the lift actuator 112 to retract the actuator piston 706 into the cylinder 708. The lift actuator 112 is connected between the chassis 102 and the header 108 such that retracting the piston 706 raises the header 108. Thus, the position control valve 704 may be used to set the operating height of the header 108. When the operating height is set, the position control valve 704 is closed (such as shown). The position control valve 704 also may include additional positions to vent hydraulic fluid from the cylinder 708 or direct fluid to the other side of the piston 706, in order to lower the header 108, or other position control valve systems may be used to lower the header 108 (e.g., a separate bleed valve located between the position control valve 704 and the actuator 112, etc.).

The hydraulic system 700 also includes an adjustable float circuit comprising an adjustable pressure reducing valve 710, a first float valve 712, an accumulator 714, and a second float valve 716. The pressure reducing valve 710 is connected to the pump 702, and can be adjusted to vary the magnitude of output pressure that is directed from via the pressure reducing valve 710 to the downstream remainder of the float circuit. Any suitable pressure reducing valve, such as a solenoid-operated or other electrically-controlled valve, may be used as the pressure reducing valve 710, as known in the art.

The first float valve 712 is located downstream of the pressure reducing valve 710, and is movable between an open position (810, FIG. 8) in which hydraulic fluid passes unimpeded in either direction, and a one-way position (FIG. 7) in which fluid can only pass downstream through the first float valve 712. Similarly, the second float valve 716 is located downstream of the first float valve 712, and configurable between an open position (816, FIG. 8) in which hydraulic fluid passes unimpeded in either direction, and a one-way position (FIG. 7) in which fluid can only pass downstream through the second float valve 716. The accumulator 714 is located in the hydraulic circuit joining the first float valve 712 to the second float valve 816. The accumulator 714 may comprise any suitable accumulator mechanism, such as a conventional adjustable gas-over-fluid accumulator having a sealed gas bladder located inside a hydraulic chamber.

The float circuit is operable to selectively connect the lift actuator 112 to pressurized hydraulic fluid to generate a force to bias the lift actuator 112 towards the retracted (i.e., lifted) position. In the position shown in FIG. 7, the first float valve 712 and second float valve 716 allow pressurized fluid to pass from the pump 702 to the lift actuator 112 to raise the header 108. However, reverse flow is not possible. Thus, external forces that raise the header 108 can pull hydraulic fluid from the pump 702 and/or accumulator 714 through the float valves 712, 716 into the actuator cylinder 708, but absent the opening of a separate vent the lift actuator 112 and header 108 cannot lower.

Moving the second float valve 716 to the open position allows reverse flow, and thus connects the actuator cylinder 708 to the accumulator 714. Thus, with the second float valve 716 open (816 as shown in FIG. 8), and the first float valve 712 closed (as in FIG. 7), the lift actuator 112 and header 108 can move up and down by compressing or expanding the gas in the accumulator 714. However, if the pressure of this circuit drops below the input pressure of the pump 702 (as limited by the pressure reducing valve 710), more hydraulic fluid will pass through the first float valve to increase fluid volume in the accumulator 714 and/or actuator cylinder 708.

FIG. 8 shows the hydraulic circuit 800 (similar to hydraulic circuit 700 in FIG. 7) with the first float valve 812 and the second float valve 816 in their respective open positions, to allow two-way flow through both valves. This configuration may be used temporarily to change the charge pressure of the accumulator 814, to thereby adjust the reaction load on the header 108 (e.g., increasing pressure in the accumulator 814 to reduce reaction forces, and vice versa).

The valve configuration in FIG. 8 also can be used continuously, to use the pressure reducing valve 810 to directly control the reaction forces at the lift actuator 112 in real time by continuously adjusting the output pressure of the pressure reducing valve 810. Specifically, pressurized fluid from the pump 802 is continuously connected to the actuator cylinder 808, and the pressure of this fluid generates a force that biases to the piston 806 towards the retracted position, and creates and upwards force at the header 108 to reduce the ground reaction force. The magnitude of this force is controlled by the pressure reducing valve 810. The output pressure of the pressure reducing valve 810 is controlled by a control system 500 that uses force feedback at the header 108, such as described above in relation to FIG. 5, by modulating the magnitude of current applied to the pressure reducing valve 810. Thus, the pressure reducing valve 810 and hydraulic circuit 800 can be operated to provide a continuous or nearly continuous ground reaction force at the header 108 by adjusting the operating pressure of the lift actuator 112.

The exemplary hydraulic circuits 700, 800 may be modified in various ways. For example, the hydraulic circuits 700, 800, or one or more elements thereof, may be duplicated to provide separate control to a second lift actuator 112 (e.g., a separate lift actuator 112 operated by a separate float circuit but using a common pump 702, 802 and hydraulic reservoir). Alternatively, a plurality of lift actuators 112 may be operatively driven by a single hydraulic circuit. Other alternatives and variations will be apparent to persons of ordinary skill in the art in view of the present disclosure.

The present disclosure describes a number of inventive features and/or combinations of features that may be used alone or in combination with each other or in combination with other technologies. The embodiments described herein are all exemplary and are not intended to limit the scope of the claims. It will also be appreciated that the inventions described herein can be modified and adapted in various ways, and all such modifications and adaptations are intended to be included in the scope of this disclosure and the appended claims.

What is claimed:

1. A method of operating a header float control system of an agricultural vehicle having a header movably mounted to a chassis, the method comprising the steps of:
determining for the header a relation between a tilt position and/or a lift position of the header and a ground reaction force between the header and a ground surface in contact with the header;
setting a desired ground reaction force between the header and a ground surface in contact with the header;
changing the tilt position and/or lift position of the header; and
adjusting a lift pressure of the header according to the relation between header tilt and/or lift position and ground reaction force to maintain the desired ground reaction force.

2. The method of claim 1, wherein determining the relation between header tilt and/or lift position and ground reaction force comprises measuring the ground reaction force between the header and the ground surface at one or more tilt and/or lift positions of the header.

3. The method of claim 1, wherein setting a desired ground reaction force comprises receiving a selection of an adjustable value for the desired ground reaction force.

4. The method of claim 3, wherein the adjustable value for the desired ground reaction force comprises an operating pressure of a hydraulic actuator that controls the lift position of the header.

5. The method of claim 1, wherein changing the tilt and/or lift position of the header comprises receiving a selection of an adjustable value for the tilt and/or lift position.

6. The method of claim 1, wherein adjusting the lift pressure of the header to maintain the desired ground reaction force comprises adjusting an operating pressure of a hydraulic actuator that controls the lift position of the header relative to the chassis.

7. The method of claim 6, wherein adjusting the operating pressure of the hydraulic actuator that controls the lift position of the header relative to the chassis comprises changing an output pressure of a pressure reducing valve operatively connected to the hydraulic actuator that controls the lift position of the header relative to the chassis.

8. An agricultural vehicle comprising:
a chassis;
a header movably mounted to the chassis by one or more lift arms, the one or more lift arms configured to adjust a lift position of the header relative to the chassis actuated by one or more lift position hydraulic actuators, and the header configured to adjust a tilt position relative to a ground surface located below the header actuated by one or more tilt position hydraulic actuators; and
a control system operatively connected to the lift and tilt actuators and configured to:
determine for the header a relation between a tilt position and/or a lift position of the header and a ground reaction force between the header and a ground surface in contact with the header;
set a desired ground reaction force between the header and a ground surface in contact with the header;
change the tilt and/or lift position of the header; and
adjust a lift pressure of the one or more lift actuators according to the relation between header tilt and/or lift position and ground reaction force to maintain the desired ground reaction force.

9. The agricultural vehicle of claim 8, wherein the control system comprises a user interface configured to receive a selection of an adjustable value for the desired ground reaction force.

10. The agricultural vehicle of claim 8, wherein the control system comprises a user interface configured to receive a selection of an adjustable value for the header tilt position and/or header lift position.

11. The agricultural vehicle of claim 8, wherein the control system is operatively connected to a pressure reducing valve that is configured to adjust the operating pressure of the one or more lift position hydraulic actuators.
